(19) United States
(12) Patent Application Publication
(10) Pub. No.: US 2024/0417642 A1
(43) Pub. Date: Dec. 19, 2024

(54) THERMOSETTING RELEASE COATING AGENT COMPOSITION AND LAMINATE

(71) Applicant: MITSUI CHEMICALS, INC., Tokyo (JP)

(72) Inventors: Yuto ICHIHARA, Chiba-shi, Chiba (JP); Yohsuke ASANO, Chiba-shi, Chiba (JP)

(21) Appl. No.: 18/708,655

(22) PCT Filed: Nov. 9, 2022
(86) PCT No.: PCT/JP2022/041672

§ 371 Date: May 9, 2024

(30) Foreign Application Priority Data
Nov. 15, 2021 (JP) 2021-185624

(51) Int. Cl. C10M 107/44; C08G 12/42; C10M 155/02; C10N 40/36; C10N 50/08

(52) U.S. Cl. CPC C10M 107/44; C08G 12/427; C10M 155/02; C10M 2217/0425; C10M 2229/02; C10N 2040/36; C10N 2050/08

(57) ABSTRACT

One aspect of the present invention is a thermosetting release coating agent composition including an alkyl etherified melamine resin (A) and an acid catalyst (B), in which an alkyl ether group in the alkyl etherified melamine resin (A) contains an ethyl ether group, and the alkyl etherified melamine resin (A) has a weight-average molecular weight of 500 to 1,100.

### TECHNICAL FIELD

One aspect of the present invention relates to a thermosetting release coating agent composition including an alkyl etherified melamine resin (A) and a laminate including a cured product layer that is formed of the thermosetting release coating agent composition.

### BACKGROUND ART

In applications where heat resistance is required, such as a release film for a ceramic green sheet among release coating agents, a melamine resin has been in use as one component thereof due to its excellent curing properties and cost.

A melamine resin is often used in a form of an alkyl etherified melamine resin obtained by modifying melamine to which formaldehyde is added with a variety of alcohols for the purpose of controlling, for example, polarity, storage stability and reactivity.

For example, a release film for a ceramic green sheet manufacturing step having a release layer containing a methyl etherified melamine resin (methylated melamine resin) as a melamine resin is being studied (refer to Patent Literature 1).

### CITATION LIST

### Patent Literature

Patent Literature 1: JP2019-166706A

### SUMMARY OF INVENTION

### Technical Problem

As described above, a methyl etherified melamine resin modified with methanol has excellent curing characteristics and has thus been generally used as a main component of release coating agents. However, a methyl ether group is highly polar and thus absorbs moisture in the air while being applied under a high-humidity condition, and there have been cases where the appearance defect such as bleaching of a coating film that is obtained by curing an applied material layer (cured coating film) occurs.

In particular, recently, the opportunity of producing a release film in a district with a high humidity (temperature) has increased due to the globalization of manufacturing bases, deterioration of the productivity arising from the above-described disadvantage has become an urgent problem, and there has been a demand for a release coating agent having low humidity dependence.

In addition, the methyl etherified melamine resin when has required curing at a relatively high temperature (for example, 120° C.) to exhibit its characteristics, but a request for decreasing carbon dioxide emission by performing curing at a low temperature is increasing year by year in consideration of a social situation such as global warming, and there is a demand for developing a variety of characteristics required for melamine resins even in the case of performing curing at a lower temperature (for example, 80° C.) than the conventional curing temperature (for example, 120° C.).

An objective of one aspect of the present invention is providing a thermosetting release coating agent composition containing an alkyl etherified melamine resin that suppresses coating film appearance defect such as bleaching in the case of having been made into a cured coating film, has excellent characteristics such as adhesion and solvent resistance even in the case of being cured at a low temperature and, furthermore, also has excellent preservation stability, and the composition.

### Solution to Problem

As a result of conducting studies, the present inventors found that, according to a thermosetting release coating agent composition containing a specific alkyl etherified melamine resin and an acid catalyst, the above-described problems can be solved.

That is, one aspect of the present invention includes the following matters.

[1] A thermosetting release coating agent composition including: an alkyl etherified melamine resin (A); and an acid catalyst (B),
wherein an alkyl ether group in the alkyl etherified melamine resin (A) contains an ethyl ether group, and the alkyl etherified melamine resin (A) has a weight-average molecular weight of 500 to 1,100.
[2] The thermosetting release coating agent composition according to [1], wherein the alkyl ether group in the alkyl etherified melamine resin (A) further contains a methyl ether group, and a mole ratio of the methyl ether group to the ethyl ether group, (methyl ether group)/(ethyl ether group), is 90/10 or less.
[3] The thermosetting release coating agent composition according to [1] or [2], wherein an average mole ratio of the alkyl ether group in the alkyl etherified melamine resin (A) to 1 mol of a triazine ring is 3 to 6.
[4] The thermosetting release coating agent composition according to any one of [1] to [3], wherein the acid catalyst (B) is p-toluenesulfonic acid.
[5] The thermosetting release coating agent composition according to any one of [1] to [4], further including: a release component (C).
[6] The thermosetting release coating agent composition according to any one of [1] to [5], wherein a concentration of carbon (C14) derived from biomass in the total organic carbon in the alkyl etherified melamine resin (A) is 20 to 100%.
[7] The thermosetting release coating agent composition according to any one of [1] to [6], wherein a content of the alkylated ether melamine resin (A) is 10 to 99 parts by weight with respect to 100 parts by weight of a solid content in the thermosetting release coating agent composition.
[8] A laminate, including a cured product layer on at least one surface of a base material, wherein the cured product layer is formed of the thermosetting release coating agent composition according to any one of [1] to [7].
[9] The laminate according to [8], wherein the base material is polyethylene terephthalate.
[10] The laminate according to [9], wherein the base material is untreated polyethylene terephthalate.

### Advantageous Effects of Invention

In a coating film that is obtained by applying and curing a thermosetting release coating agent containing an alkyl etherified melamine resin according to one aspect of the present invention, a coating film appearance defect such as bleaching is suppressed, and characteristics such as adhesion and solvent resistance are excellent even in a case where the thermosetting release coating agent is cured at a low temperature. In addition, the thermosetting release coating agent is also excellent in terms of preservation stability.

### DESCRIPTION OF EMBODIMENTS

### [Thermosetting Release Coating Agent Composition]

In a thermosetting release coating agent composition according to one aspect of the present invention, an alkyl etherified melamine resin (A) and an acid catalyst (B) are contained.

### <Alkyl Etherified Melamine Resin (A)>

In the thermosetting release coating agent composition according to one aspect of the present invention, an alkyl etherified melamine resin (A) is contained. Here, a melamine resin is a resin that is obtained from a raw material containing melamine and formaldehyde, and an alkyl etherified melamine resin that is one example thereof is a resin that is obtained from a raw material containing melamine, formaldehyde and an alcohol that is used for alkyl etherification.

The alkyl etherified melamine resin (A) contains an ethyl ether group as an alkyl ether group in the resin. When an ethyl ether group is contained as the alkyl ether group in the alkyl etherified melamine resin, an appearance defect of a coating film (cured coating film) that is obtained by applying and curing the thermosetting release coating agent composition containing the alkyl etherified melamine resin (A) is suppressed, and adhesion to a base material and storage stability at a low temperature improve.

From the viewpoint of suppressing an appearance defect of a coating film (cured coating film) that is obtained from the thermosetting release coating agent composition according to one aspect of the present invention and, furthermore, improving solvent resistance, the alkyl etherified melamine resin (A) preferably further contains a methyl ether group.

In a case where an ethyl ether group and a methyl ether group are contained in the alkyl etherified melamine resin (A), the mole ratio of the methyl ether group to the ethyl ether group, (methyl ether group)/(ethyl ether group), is preferably 90/10 or less, more preferably 50/50 or less and still more preferably 30/70 or less from the viewpoint of improving solvent resistance.

In addition, in a case where an ethyl ether group and a methyl ether group are contained, the mole ratio (methyl ether group)/(ethyl ether group) is normally 5/95 or more.

From the viewpoint of more significantly developing the effect of the present invention, the total content of the ethyl ether group and the methyl ether group, which is contained as necessary, with respect to all alkyl ether groups in the alkyl etherified melamine resin (A) is preferably 80 to 100 mol % and more preferably 90 to 100 mol %. In addition, from the same viewpoint, all of the alkyl ether groups are preferably only the ethyl ether group or only the ethyl ether group and the methyl ether group and more preferably only the ethyl ether group and the methyl ether group.

Gas chromatography-mass spectrometry (GC) makes it possible to identify the kind of the alkyl ether group in the alkyl etherified melamine resin (A) and makes it possible to obtain the contents and mole ratio thereof in a case where a plurality of alkyl ether groups is contained.

Since an alcohol that is detected by measurement (for example, ethanol or methanol) is derived from the alkyl ether group in the alkyl etherified melamine resin (A), the number (mole) of the alkyl ether group in the alkyl etherified melamine resin (A) can be obtained from the amount of the alcohol generated, which is to be calculated.

The polystyrene-equivalent weight-average molecular weight (Mw) of the alkyl etherified melamine resin (A) measured by GPC (gel permeation chromatography) is 500 to 1,100 and preferably 600 to 1,100. When the weight-average molecular weight of the alkyl etherified melamine resin (A) is within the above-described range, not only does solvent resistance improve, but an appearance defect of a coating film (cured coating film) that is obtained from the thermosetting release coating agent composition is also suppressed, and the adhesion between the coating film that is obtained from the thermosetting release coating agent composition and a base material is excellent even in a case where the thermosetting release coating agent composition is cured at a relatively low temperature. In addition, the thermosetting release coating agent is excellent in terms of storage stability at a low temperature.

From the viewpoint of improving the solvent resistance of a coating film (cured coating film) that is obtained from the thermosetting release coating agent composition of the present invention, the average mole ratio of the alkyl ether group in the alkyl etherified melamine resin (A) to 1 mol of a triazine ring which is a melamine skeleton component is preferably 3 to 6 and more preferably 4 to 6.

In a case where the average mole ratio of the alkyl ether group to 1 mol of the triazine ring is less than 3, the crosslink density is not sufficient, and there is a concern of deterioration of the solvent resistance.

The mole numbers of the alkyl ether group and the triazine ring in the alkyl etherified melamine resin (A) can be obtained from a nuclear magnetic resonance spectrum (¹³C-NMR).

From the viewpoint of suppressing the use of a raw material derived from a fossil fuel and obtaining a resin capable of contributing to environment preservation, the concentration of carbon (C14) derived from biomass in the total organic carbon in the alkyl etherified melamine resin (A) is preferably 20 to 100% and more preferably 30 to 100%.

The concentration of carbon (C14) derived from biomass in the alkyl etherified melamine resin (A) was obtained based on Standards of American Society for Testing and Materials (ASTM D6866 Method B). A calculation method will be described in detail in examples to be described below.

The content of the alkyl etherified melamine resin (A) in the thermosetting release coating agent composition according to one aspect of the present invention is preferably 10 to 99 parts by weight and more preferably 50 to 98 parts by weight with respect to 100 parts by weight of a solid content in the composition.

A method for producing the alkyl etherified melamine resin (A) is not particularly limited as long as a resin satisfying the requirements can be produced. The method for producing the alkyl etherified melamine resin (A) preferably has a step of, first, performing a methylolation reaction using, for example, melamine and formaldehyde and then performing an alkyl etherification reaction and more preferably has a step of charging melamine, formaldehyde and an alcohol into a reaction vessel, heating the components up to a reflux temperature, and then performing a condensation reaction of the three components using an acid as a catalyst.

### [Melamine]

The melamine is not particularly limited and may be synthesized by a well-known conventional method or may be a commercially available product.

### [Formaldehyde]

The formaldehyde may be an aqueous solution or may be solid paraformaldehyde. From the viewpoint of economic efficiency, paraformaldehyde having a formaldehyde concentration of 80% or higher is preferable.

The amount of the formaldehyde used is preferably 3 to 12 mol and more preferably 4 to 10 mol when the amount of the melamine used is set to 1 mol. When the amount of the formaldehyde used is within the above-described range, it is possible to efficiently produce the alkyl etherified melamine resin (A) that is used in the present invention.

### [Alcohol]

The use of ethanol as the alcohol in the above-described step makes it possible to produce an ethyl etherified melamine resin. When this ethyl etherified melamine resin is used, an appearance defect of a coating film (cured coating film) that is obtained from the thermosetting release coating agent composition is also suppressed, and the adhesion between the coating film that is obtained from the thermosetting release coating agent composition and a base material is excellent even in a case where the thermosetting release coating agent composition is cured at a relatively low temperature.

Here, when methanol is used as the alcohol, it is possible to obtain a methyl etherified melamine resin, but the appearance of a coating film (cured coating film) is likely to become poor. In addition, when butanol is used as the alcohol, it is possible to obtain a butyl etherified melamine resin, and the appearance of a coating film (cured coating film) is less likely to become poor, but it is considered that a crosslinking reaction is slow and there is thus a tendency that the solvent resistance of a cured product to be obtained deteriorates.

The amount of the ethanol used is preferably 3 to 20 mol and more preferably 5 to 12 mol when the amount of the melamine used is set to 1 mol. When the amount of the ethanol used is within the above-described range, it is possible to efficiently and inexpensively produce the alkyl etherified melamine resin (A) that is used in the present invention.

A mixture of ethanol and a small amount of a different alcohol represented by CₙH₂ₙ₊₁OH (n is 1 or an integer of 3 to 8) may also be used as long as the object of the present invention is not impaired.

From the viewpoint of economic efficiency and the performance of a coating film (cured coating film), n is preferably 1, 3 or 4.

### <Acid Catalyst (B)>

In the thermosetting release coating agent composition of the present invention, an acid catalyst (B) is further contained. The acid catalyst (B) contained makes it possible for the above-described condensation (crosslinking) reaction by the melamine resin to more efficiently proceed.

As the acid catalyst (B), any of an organic acid and an inorganic acid can be used; and examples of the organic acid include formic acid, oxalic acid, methanesulfonic acid, p-toluenesulfonic acid, dodecylbenzenesulfonic acid and alkyl phosphate, and examples of the inorganic acid include phosphoric acid, phosphorous acid, hydrochloric acid, sulfuric acid, nitric acid and hydrobromic acid.

Among the acid catalyst (B), organic acids are preferable, p-toluenesulfonic acid, methanesulfonic acid and dodecylbenzenesulfonic acid are more preferable, and p-toluenesulfonic acid is particularly preferable. These have high acidity and excellent reactivity and are thus capable of processing a mold release layer at a lower temperature. Therefore, it is possible to suppress deterioration of the flatness of a film due to heat during processing or deterioration of a rolled appearance.

The content of the acid catalyst (B) in the thermosetting release coating agent composition of the present invention is preferably 1 to 10 parts by weight and more preferably 3 to 8 parts by weight with respect to 100 parts by weight of the alkyl etherified melamine resin (A). When the content of the acid catalyst (B) is within the above-described range, a curing reaction efficiently proceeds, additionally, there is no concern that the acid catalyst may migrate to a target object (for example, a ceramic green sheet to be described below) that is used in a state of being laminated on a cured product layer (typically a release layer) that is obtained by curing the composition, and durability is excellent.

### <Release Component (C)>

In the thermosetting release coating agent composition according to one aspect of the present invention, a release component (C) is preferably contained. This release component (C) is not particularly limited as long as the release component is capable of imparting a desired releasing property to a cured product layer (release layer), and examples thereof include releasable polymer components such as polyorganosiloxane, silicone-modified acrylic resins, fluororesins and acrylic resins. Among these, polyorganosiloxane is preferable. The releasable polymer components may be each used singly or may be used jointly or in a mixture form.

In the thermosetting release coating agent composition according to one aspect of the present invention, the release component (C) is preferably a releasable polymer component having one or more functional groups capable of chemically bonding to the alkyl etherified melamine resin (A) in one molecule. Examples of such functional groups include an alkoxy group such as a methoxy group, a hydroxy group, an amino group, a carboxyl group, an epoxy group, a thiol group, an isocyanate group. When the release component (C) has the functional group, the releasable polymer component (for example, polyorganosiloxane) can be fixed to a melamine cured product by a condensation reaction with the melamine resin, as a result, it is possible to suppress migration of a component derived from the release component (C) to a target object (for example, a ceramic green sheet) that is used in a state of being laminated on a cured product layer (release layer) that is obtained by curing the thermosetting release coating agent composition, and it is possible to prevent the release force from becoming large during tape storage or prevent the pressure-sensitive adhesive force from decreasing during use.

In a case where the release component (C) is polyorganosiloxane, the weight-average molecular weight (Mw) thereof is preferably 1,000 or more and 10,000 or less, more preferably 9,000 or less and particularly preferably 3,000 or more and 8,000 or less. When the weight-average molecular weight of polyorganosiloxane is within the above-described range, the compatibility of polyorganosiloxane and the melamine resin becomes superior, and it becomes easy to form a release layer having an excellent surface state. In addition, it becomes easy to adjust the surface free energy on the release surface to an appropriate range. As a result, it becomes easy to satisfy both excellent releasability and excellent slurry coatability in a laminate (for example, a release film) according to one embodiment of the present invention.

As the above-described release component (C), examples of polyorganosiloxane having a hydroxyl group include BYK-370, BYK-375, BYK-377 and BYK-SILCLEAN manufactured by BYK Japan KK, x-22-4952 manufactured by Shin-Etsu Chemical Co., Ltd. and FM-4425 manufactured by JNC Co., Ltd.; examples of polyorganosiloxane having a carboxyl group include x-22-162C, x-22-3701E and x-22-3710 manufactured by Shin-Etsu Chemical Co., Ltd. and BY16-750 and BY16-880 manufactured by Dow Corning Toray Silicone Co., Ltd.; examples of polyorganosiloxane having a mercapto group include x-22-167B manufactured by Shin-Etsu Chemical Co., Ltd.; examples of polyorganosiloxane having an amino group include x-22-161B manufactured by Shin-Etsu Chemical Co., Ltd.; examples of polyorganosiloxane having an epoxy group include x-22-163B manufactured by Shin-Etsu Chemical Co., Ltd.

The content of the release component (C) in the thermosetting release coating agent composition according to one aspect of the present invention is preferably 0.1 to 20 parts by weight and more preferably 0.5 to 10 parts by weight with respect to 100 parts by weight of the alkyl etherified melamine resin (A). When the content of the release component (C) is within the above-described range, it is easy to achieve desired releasability with respect to a target object (for example, a ceramic green sheet) on which a cured product layer (release layer) that is obtained by curing the thermosetting release coating agent composition is laminated, and it becomes possible to effectively suppress migration of polyorganosiloxane to the target object from the release layer.

### <Solvent>

In the thermosetting release coating agent composition according to one aspect of the present invention, normally, a solvent is contained in consideration of, for example, the coatability. Even in a case where a solvent is contained in the thermosetting release coating agent composition as described above, when the alkyl etherified melamine resin (A) is contained as the melamine resin, the storage stability is excellent even in the case of preserving the composition at a low temperature.

The solvent is not particularly limited, but needs to be capable of dissolving the above-described components. Examples of the solvent include hydrocarbon compounds such as toluene, xylene, hexane and heptane; alcohol compounds such as methanol, ethanol, 1-butanol, isopropyl alcohol and isobutyl alcohol; ketone compounds such as acetone, methyl ethyl ketone and methyl isobutyl ketone; ester compounds such as ethyl acetate and butyl acetate; ether compounds such as diisopropyl ether and 4-dioxane. One of these may be used singly or two or more may be appropriately combined and used.

In one aspect of the present invention, from the viewpoint of dissolving the release component (C), toluene and methyl ethyl ketone are preferably used, and toluene is more preferably used.

In a case where a solvent is contained in the thermosetting release coating agent composition according to one aspect of the present invention, from the viewpoint of the coatability, the amount of the solvent blended is preferably 420 to 1995 parts by weight and more preferably 595 to 1395 parts by weight with respect to 100 parts by weight of the alkyl etherified melamine resin (A).

### <Other Components>

The thermosetting release coating agent composition according to one aspect of the present invention may contain other components to an extent that the effect of the present is not impaired. Examples of the other components include additives such as a binder, a crosslinking agent, a reaction inhibitor, an adhesion improver, a slip agent, an antistatic agent, an antioxidant, a leveling agent, a filler, an antifoaming agent and a pigment.

### [Binder]

The binder is not particularly limited as long as the binder is a compound having two or more hydroxyl groups in one molecule (here, the alkyl etherified melamine resin (A) is excluded), and a variety of well-known binders can be used.

Specific examples thereof include aliphatic diols such as ethylene glycol, 2-methyl-1,3-propanediol, 1,6-hexanediol, 3-methyl-1,5-pentanediol, neopentyl glycol, 2-methyl-1,5-pentanediol, 2,2-diethyl-1,3-propanediol, 1,9-nonanediol, 1,10-decanediol, butylethylpropanediol and butylethylpentanediol; alicyclic diols such as 1,4-cyclohexanedimethanol; trimethylolpropane, pentaerythritol, ditrimethylolpropane, dipentaerythritol, dimer diol, hydrogenated dimer diol, trimer triol, hydrogenated trimer triol, castor oil, castor oil-based modified polyol and alkylene oxide adducts of a bisphenol compound or a derivative thereof. In addition, examples thereof also include polymer polyols such as polyether polyols, polyester polyols, polycarbonate polyols, acrylic polyols and polyolefin polyols. These may be used singly or two or more thereof may be combined.

### [Crosslinking Agent]

The crosslinking agent is not particularly limited as long as the crosslinking agent is a compound having a functional group capable of bonding to a hydroxyl group, and a variety of well-known crosslinking agents can be used.

Specific examples thereof include isocyanate-based curing agents, epoxy-based curing agents, aziridine-based curing agents, carbodiimide-based curing agents and oxazoline-based curing agent. These may be used singly or two or more thereof may be combined.

The binder and the crosslinking agent can be both used to improve the curing properties of the thermosetting release coating agent composition of the present invention. In addition, the contents of the binder and the crosslinking agent are not particularly limited as long as the effect of the present invention is not impaired as described above.

### [Laminate and Release Film]

A laminate including a cured product layer (typically, a release layer) that is a coating film obtained from the thermosetting release coating agent composition and a base material can be formed by applying the thermosetting release coating agent composition according to one aspect of the present invention obtained as described above onto the base material to produce an applied material layer and curing this applied material layer by typically heating. A laminate according to one aspect of the present invention is suitably used as a release film.

### <Base Material>

Examples of the base material of the laminate (for example, release film) include films made of a polyester such as polyethylene terephthalate (PET) or polyethylene naphthalate, a polyolefin such as polypropylene or polymethylpentene or plastic such as polycarbonate or polyvinyl acetate, and the base material may be a single layer or a multilayer of two or more layers of the same kind or different kinds. Among these, a polyester film is preferable, and, particularly, a polyethylene terephthalate film is preferable.

Since dust or the like is less likely to be generated during, for example, the processing or use of the PET film, it is possible to effectively prevent, for example, poor ceramic slurry coating caused by dust or the like. Furthermore, when an antistatic treatment is performed on the PET film, it is possible to prevent ignition by static electricity at the time of applying a ceramic slurry in which an organic solvent is used or to enhance an effect of preventing, for example, poor coating. In order to improve the adhesion between these base material and the cured product layer (release layer), a corona treatment, an etching treatment or a plasma treatment may be performed on the base material surface, unevenness may be imparted to the base material surface by adding organic or inorganic particles thereto or a base material coated with urethane or polyester may be used. In the present specification, base materials on which the above-described treatment is not performed will be referred to as “untreated” based materials.

An untreated base material may be used as the base material, and the thermosetting release coating agent composition of the present invention is also excellent in terms of, for example, adhesion to untreated PET films.

### <Cured Product Layer and Release Layer>

The cured product layer (typically a release layer) of the laminate (for example, a release film) can be formed by applying the thermosetting release coating agent composition according to one aspect of the present invention onto one surface of the base material and curing the composition by typically heating. The cured product layer (release layer) of this laminate is formed of the thermosetting release coating agent composition according to one aspect of the present invention and thus has excellent adhesion to the base material (for example, a PET film) even in the case of being cured at a relatively low temperature.

The thickness of the cured product layer (release layer) is preferably 0.01 μm or more, more preferably 0.03 μm or more, still more preferably 0.05 μm or more and particularly preferably 0.1 μm or more. In addition, the thickness is preferably 2.0 μm or less, more preferably 1.0 μm or less and still more preferably 0.5 μm or less. When the thickness of the release layer is 0.01 μm or more, for example, in a case where the laminate is used as a release film, the release layer exhibits sufficient releasability with respect to a target object (for example, a ceramic green sheet) that is used in a state of being laminated on the cured product layer (release layer). In addition, when the thickness of the cured product layer (release layer) is 2.0 μm or less, it is possible to suppress the occurrence of blocking when the release film has been wound in a roll shape. For example, in a case where the release film is used to mold a ceramic green sheet, the curing time can be shortened, and the flatness of the release film is held, which makes it possible to suppress thickness unevenness in the ceramic green sheet to be obtained.

The cured product layer (release layer surface) that is obtained from the thermosetting release coating agent composition according to one aspect of the present invention is desirably flat. For example, in a case where a laminate that is obtained from the composition is used as a release film to mold a ceramic green sheet, if the cured product layer surface (release layer surface) is flat, it is possible to suppress a defect such as a pinhole or thickness unevenness in the ceramic green sheet that is to be applied and molded on the cured product layer surface (release layer surface). When the cured product layer (release layer) is formed of a release agent composition containing a dispersant, the compatibility of components in the release agent composition improves, and consequently, it becomes easy for the cured product layer (release layer) to be flat.

### <Fabrication of Laminate and Release Film>

A method for applying the thermosetting release coating agent composition of the present invention to the base material to fabricate the laminate (for example, the release film) is not particularly limited as long as it is possible to form a layer made of an applied material on the base material, and the layer can be fabricated by a well-known method such as a gravure coating method, a bar coating method, a spray coating method, a spin coating method, a knife coating method, a roll coating method or a die coating method.

The applied material that has been applied onto the base material and is formed of the thermosetting release coating agent composition according to one aspect of the present invention is made into the cured product layer (typically the release layer) in the laminate (release film) by removing a volatile component (for example, the solvent) of the applied material to cure a solid content in the applied material.

The amount of the applied material applied is preferably 0.01 to 100 g/m² and more preferably 0.03 to 50 g/m². In a case where the cured product layers (release layers) are made on both surfaces of the base material, it is preferable to perform an operation for forming the cured product layer (release layer), which is a cured product film, on the surfaces of the base material one by one.

The solid content in this thermosetting release coating agent composition is normally cured by heating. Regarding the heating conditions for this curing, the solid content can be cured at a low temperature compared with conventional cases in the case of using the thermosetting release coating agent composition according to one aspect of the present invention. The heating temperature for curing the thermosetting release coating agent composition is preferably 60° C. or higher and 140° C. or lower and more preferably 80° C. or higher and 120° C. or lower. In a case where it is intended to cure the solid content at a relatively low temperature, it is possible to cure the solid content by selecting a temperature range of 70° C. or higher and 90° C. or lower. In addition, the heating time for curing is preferably 0.5 minutes or longer and 5 minutes or shorter and more preferably 1 minute of longer and 3 minutes or shorter.

As described above, in the present invention, curing at a relatively low temperature is possible, and it is thus possible to expect a decrease in carbon dioxide emission that is caused during heating.

### [Ceramic Green Sheet]

The laminate obtained as described above is suitably used as a release film, and the release film is suitably used in a step of producing a ceramic green sheet film. This ceramic green sheet film serves as a raw material of, for example, a multilayer ceramic capacitor film.

The multilayer ceramic capacitor film is generally a film having the following configuration. The multilayer ceramic capacitor film has a rectangular ceramic element. In the multilayer ceramic capacitor film, it is normal that a first internal electrode and a second internal electrode are alternately provided along the thickness direction in this ceramic element. This first internal electrode is exposed on a first end face of the ceramic element, and a first external electrode is provided on the first end face of the ceramic element. The first internal electrode is electrically connected with the first external electrode on the first end face. The second internal electrode is exposed on a second end face of the ceramic element. A second external electrode is provided on the second end face. The second internal electrode is electrically connected with the second external electrode on the second end face.

A ceramic green sheet that serves as a raw material of such a multilayer ceramic capacitor film can be fabricated as described below using the release film.

First, a ceramic slurry containing a ceramic material such as barium titanate or titanium oxide is applied to the release surface of the release film. The ceramic slurry can be applied using, for example, a slot die coating method or a doctor blade method. In addition, examples of a binder component in the ceramic slurry include a butyral-based resin and an acrylic resin. Examples of a solvent in the ceramic slurry include an organic solvent and a water-based solvent. Subsequent to the application of the slurry to the release surface, the applied ceramic slurry is dried, whereby a ceramic green sheet can be molded. Regarding the thickness of the ceramic green sheet, it has been normal to obtain an extremely thin product of 0.2 to 1.0 μm.

The fabricated ceramic green sheet is used as a raw material of the multilayer ceramic capacitor film after conductive layers for configuring the first or second internal electrode are each printed thereon. A multilayer ceramic capacitor can be produced by dividing a laminate obtained by appropriately laminating and pressing these sheets into a plurality of pieces, firing the plurality of pieces to obtain ceramic elements and then forming first and second external electrodes.

### [Transfer Foil Sheet]

In addition, the release film obtained as described above is also suitably used in the fabrication of a transfer foil sheet as a mold release film for a transfer foil or a release film for decoration such as a transfer film. Regarding the configuration of a transfer foil sheet for which the film is used, the transfer foil sheet generally has a configuration in which the release layer is provided on one surface of a polyester film, which is a base material film, and a pattern printing layer, a coloring layer and a transfer layer such as an adhesive layer are sequentially laminated on the release layer. For example, a hard coat layer or a metal vapor-deposited layer is laminated on the transfer layer depending on the purpose. Furthermore, a function as a transfer foil is imparted by adding a functional agent such as an antistatic agent or an antibacterial agent to the release layer or the transfer layer.

As a method for transferring a transfer foil for which the release film as described above is used, for example, a thermal transfer method (hot stamp method) or a molding simultaneous transfer method (in-mold molding method) is generally known. Regarding a transfer target material to which the transfer layer is to be transferred, a material thereof is not particularly limited and examples thereof include molded products made of, for example, glass, a metal, a ceramic or a resin, paper and cloth. In addition, regarding the shape of the transfer target material as well, for example, materials molded in advance in a plate shape, a film shape, a sheet shape or a desired shape can be used with no particular limitations. As described above, the transfer foil sheet is in use in a wide range of applications for the purpose of performing surface processing such as decoration or surface protection on the surface of the transfer target material.

### EXAMPLES

Hereinafter, the present invention will be more specifically described based on examples, but the present invention is not limited to these examples.

Methods for measuring the physical properties of materials used in the examples and comparative examples are as described below.

### <Weight-Average Molecular Weight>

The weight-average molecular weight of the alkyl etherified melamine resin (A) was measured by GPC under the following conditions.
Device: Shodex GPC-101 manufactured by Showa Denko K. K.
Detector: RI-71S
Column: Three GPCKF804L (Φ8.0 mm×300 mm) manufactured by Showa Denko K. K.
Measurement temperature: 40° C.
Eluent: THF (tetrahydrofuran)
Flow rate: 1.0 ml/min.

### <Alkyl Ether Group Content Ratio>

For the alkyl ether group content ratio of the alkyl etherified melamine resin (A), 20 mg (or 10 mg) of a sample (melamine resin) was put into a 20 ml vial container, tightly stoppered and heated at 150° C. for 30 minutes using a headspace sampler (G1888 manufactured by Agilent Technologies), and the headspace gas was measured by gas chromatography-mass spectrometry (GC) using a gas chromatograph (6890GC/5973MSD manufactured by Agilent Technologies).

Here, for example, in a case where the content of methanol as the alcohol was measured, the amount generated was obtained by an absolute calibration curve method using the peak area of a holding time obtained by performing extracted ion chromatogram processing for which a characteristic cleavage ion was used on the mass spectrum of ethanol. In a case where the content of methanol was measured, the amount generated was obtained by the absolute calibration curve method using the peak area of a holding time. The mole ratio of a methyl ether group to an ethyl ether group was calculated from these amounts generated.

### <Average Mole Ratio of Alkyl Ether Group to 1 Mol of Triazine Ring>

For the average mole ratio of the alkyl ether group to 1 mol of a triazine ring of the alkyl etherified melamine resin (A), a sample from which a dilution solvent had been volatilized (melamine resin) was dissolved in heavy DMSO, and ¹³C-NMR measurement was performed under the following conditions.
Device: AVANCE NEO cryo-500 nuclear magnetic resonance device manufactured by Bruker
Measurement nucleus: 13C (125 MHZ)
Measurement mode: Single pulse inverse gated proton decoupling
Pulse width: 90 degrees (10.0 μs)
Point count: 64 times
Observation range: 250 ppm (−25 to 225 ppm)
Number of times of repetition: 20.0 s
Accumulation count: 64 times
Measurement temperature: 25° C.
Window function: Exponential (BF: 1.0 Hz)

Integral ratios were calculated based on the following attribution, and the mole ratio of the alkyl ether group to the triazine ring was obtained.
Triazine ring: 164 to 169 ppm
Methyl ether group: 54 to 58 ppm
Ethyl ether group: 61 to 63 ppm
Butyl ether group: 30 to 34 ppm
   <Concentration of Carbon (C14) Derived from Biomass>

The concentration of carbon (C14) derived from biomass of the alkyl etherified melamine resin (A) was determined by, as described in ASTM (American Standard Testing Method) D6866 04 (Standard Test Method for Determining the Biobased Content of Natural Range Materials Using Radiocarbon and Isotope Ratio Mass Spectrometry Analysis), combusting a sample to produce CO₂, putting an accurately quantified CO₂ gas into an AMS (accelerated mass spectrometry) device to measure the amounts of carbon of mass number 14 and carbon of mass number 12 or mass number 13 and comparing the amounts with the abundance ratio of carbon of mass number 14 that is present in the air or in a petrochemical.

### Production Example 1

126 g (1 mol) of melamine, 294 g (9 mol) of paraformaldehyde having a formaldehyde concentration of 92%, 460 g (10 mol) of ethanol and 0.04 g (1 mmol) of sodium hydroxide were charged into a four-neck flask including a stirrer, a thermometer, a reflux condenser and a nitrogen introduction tube and heated up to a reflux temperature. 1 g (5.8 mmol) of p-toluenesulfonic acid was added thereto to perform a first alkyl etherification reaction at the reflux temperature, then, the reaction product was neutralized with 0.8 g (0.02 mol) of sodium hydroxide, and ethanol was then distilled away under reduced pressure. Again, 1 g (5.8 mmol) of p-toluenesulfonic acid and 460 g (10 mol) of ethanol were added thereto to complete a second alkyl etherification reaction, the reaction product was neutralized with 0.8 g (0.02 mol) of sodium hydroxide, next, ethanol was distilled away under reduced pressure, and the reaction product was diluted with isobutanol so that the amount of a non-volatile component reached 60 weight %, thereby obtaining a melamine resin (A-1).

The average mole ratio of the alkyl ether group to 1 mol of a triazine ring of the obtained melamine resin (A-1) was 4.5, and Mw was 1000.

### Production Examples 2 to 5

Melamine resins (A-2) to (A-4) and (A′-1) were produced in the same manner as the melamine resin (A-1) except that the kinds and amounts of the alcohol to be used were changed as shown in Table 1. Thus, Melamine resins (A-2) to (A-4) and (A′-1) were obtained. The physical properties of the obtained resins are shown in Table 2.

TABLE 1

| | | First reaction | | Second reaction | |
|---|---|---|---|---|---|
| Melamine | Production | Methanol | Ethanol | Methanol | Ethanol |
| resin | Example | (g) | (g) | (g) | (g) |
| (A-1) | Production | 0 | 460 | 0 | 460 |
| | Example 1 | | | | |
| (A-2) | Production | 80 | 345 | 80 | 345 |
| | Example 2 | | | | |
| (A-3) | Production | 160 | 230 | 160 | 230 |
| | Example 3 | | | | |
| (A-4) | Production | 256 | 92 | 256 | 92 |
| | Example 4 | | | | |
| (A′-1) | Production | 320 | 0 | 320 | 0 |
| | Example 5 | | | | |

### Production Example 6

126 g (1 mol) of melamine, 163 g (5 mol) of paraformaldehyde having a formaldehyde concentration of 92% and 368 g (8 mol) of ethanol were charged into a four-neck flask including a stirrer, a thermometer, a reflux condenser and a nitrogen introduction tube and heated up to a reflux temperature. After a methylolation reaction was performed at the reflux temperature for one hour, 0.2 g (1.2 mmol) of p-toluenesulfonic acid was added to perform an alkyl etherification reaction for three hours in a refluxed state. After that, the reaction product was neutralized with triethanolamine, next, ethanol was distilled away under reduced pressure, and the reaction product was diluted with isobutanol so that the amount of a non-volatile component reached 60 weight %, thereby obtaining a melamine resin (A′-2).

The average mole ratio of the alkyl ether group to 1 mol of a triazine ring of the obtained melamine resin (A′-2) was 1.8, and Mw was 1,200.

### Production Example 7

126 g (1 mol) of melamine, 163 g (5 mol) of paraformaldehyde having a formaldehyde concentration of 92%, 593 g (8 mol) of butanol and 0.2 g (1.2 mmol) of p-toluenesulfonic acid were charged into a four-neck flask including a stirrer, a thermometer, a reflux condenser and a nitrogen introduction tube and heated up to a reflux temperature. After a methylolation reaction was performed at the reflux temperature for one hour, an alkyl etherification reaction was performed for three hours in a refluxed state while dehydration was performed. After that, the reaction product was neutralized with triethanolamine, next, butanol was distilled away under reduced pressure, and the reaction product was diluted with isobutanol so that the amount of a non-volatile component reached 60 weight %, thereby obtaining a melamine resin (A′-3).

The average mole ratio of the alkyl ether group to 1 mol of a triazine ring of the obtained melamine resin (A′-3) was 2.2, and Mw was 3,800.

TABLE 2

| | | | Average mole | | |
|---|---|---|---|---|---|
| | | | ratio of alkyl | | C14 |
| | | Alkyl ether | ether group/1 | | concen- |
| Melamine | Production | group content | mol of triazine | | tration |
| resin | Example | ratio | ring | Mw | (%) |
| (A-1) | Production | Me/Et = | 4.5 | 1000 | 56 |
| | Example 1 | 0/100 | | | |
| (A-2) | Production | Me/Et = | 4.5 | 900 | 38 |
| | Example 2 | 25/75 | | | |
| (A-3) | Production | Me/Et = | 4.6 | 900 | 20 |
| | Example 3 | 50/50 | | | |
| (A-4) | Production | Me/Et = | 4.6 | 900 | 8 |
| | Example 4 | 80/20 | | | |
| (A′-1) | Production | Me/Et = | 4.7 | 800 | 0 |
| | Example 5 | 100/0 | | | |
| (A′-2) | Production | Me/Et = | 1.8 | 1200 | 33 |
| | Example 6 | 0/100 | | | |
| (A′-3) | Production | Me/Et/Bu = | 2.2 | 3800 | 0 |
| | Example 7 | 0/0/100 | | | |

Me = Methyl ether group,
Et = ethyl ether group,
Bu = butyl ether group

### Example 1

100 Parts by weight (solid content-equivalent value, which also applies below) of the melamine resin (A-1) and 5 parts weight of p-toluenesulfonic acid as the acid catalyst (B) were mixed together in toluene, thereby obtaining a blended liquid for a release coating agent composition having a solid content of 10 weight %.

The obtained blended liquid was uniformly applied onto a single surface of an untreated PET film (thickness: 38 μm) as a base material by a bar coating method under conditions of 25° C. and 80% RH. Next, the obtained applied material layer (uncured coating film) was cured by being heated and dried at 80° C. for one minute, thereby obtaining a release film having a cured product layer (release layer) having a thickness of 1.0 μm laminated on the base material.

### Examples 2 to 7 and Comparative Examples 1 to 4

Blended liquids and release films were obtained in the same manner as in Example 1 except that the kind of the melamine resin, the release component (C) (polyester-modified hydroxyl group-containing polyorganosiloxane (manufactured by BYK Japan KK, trade name: BYK-370, weight-average molecular weight: 5000)) or other component (trimethylolpropane as a binder) were used in amounts shown in Table 3.

Methods for measuring the physical properties of the blended liquids and the release films obtained in the above-described examples and comparative examples are as described below.

### <Preservation Stability (Blended Liquid Low-Temperature Stability)>

The low-temperature stability of the blended liquids obtained in Examples 1 to 7 and Comparative Examples 1 to 4 was visually evaluated based on the following standards. The results are shown in Table 3.
O: No blended components were precipitated after the blended liquid was placed still at 0° C. for 24 hours.
X: A blended component was precipitated after the blended liquid was placed still at 0° C. for 24 hours.

### <Coating Film (Cured Coating Film) Appearance>

The coating film appearances of the release films obtained in Examples 1 to 7 and Comparative Examples 1 to 4 were each visually evaluated based on the following standards. The results are shown in Table 3.
OO: Bleaching was not shown in the film.
O: Bleaching was shown in a part of the film, which was not on a practically problematic level.
X: Bleaching was shown in the entire film.

### <Adhesion (Untreated PET Adhesion)>

Cross-cut release tests were performed on the release films obtained in Examples 1 to 7 and Comparative Examples 1 to 4 according to (JIS K 5600 May 6), and the adhesion was evaluated based on the following standards. The results are shown in Table 3. In a case where no cells out of 100 cells are released, the number of adhesion parts is 100/100, and, in a case where all cells are released, the number of adhesion parts is 0/100.
O: The number of adhesion parts between the base material and the coating film after release was 100/100.
X: The number of adhesion parts between the base material and the coating film after release was 0/100 to 99/100.

### <Solvent Resistance>

The release films obtained in Examples 1 to 7 and Comparative Examples 1 to 4 were rubbed with gauze immersed with methyl ethyl ketone, and the numbers of times of rubbing until the base material was exposed were evaluated based on the following standards. The results are shown in Table 3.
OO: The base material was not exposed even after the release film was rubbed 80 or more times.
O: The base material was exposed when the release film was rubbed 50 to 79 times.
X: The base material was exposed when the release film was rubbed 0 to 49 times.

### <Release Force>

Polyester-based pressure-sensitive adhesive tape (31B/manufactured by Nitto Denko Corporation) was pasted to the release layer surfaces of the release films obtained in Examples 1 to 7 and Comparative Examples 1 to 4 for a test specimen while being crimped at a load of 2 kg, and tensile release forces (N/25 mm) at an angle of 180 degrees and a release rate of 0.3 m/min. were calculated. The results are shown in Table 3.

TABLE 3

| | | Example 1 | Example 2 | Example 3 | Example 4 |
|---|---|---|---|---|---|
| Melamine resin | (A-1) | 100 | | | |
| | (A-2) | | 100 | | |
| | (A-3) | | | 100 | |
| | (A-4) | | | | 100 |
| | (A′-1) | | | | |
| | (A′-2) | | | | |
| | (A′-3) | | | | |
| Acid catalyst (B) | Paratoluenesulfonic acid | 5 | 5 | 5 | 5 |
| Release | Polyorganosiloxane | | | | |
| component (C) | | | | | |
| Solvent | Toluene | 945 | 945 | 945 | 945 |
| Other component | Trimethylolpropane | | | | |
| Physical properties | Coating film appearance | ◯◯ | ◯◯ | ◯ | ◯ |
| (after curing) | Untreated PET adhesion | ◯ | ◯ | ◯ | ◯ |
| | Solvent resistance | ◯ | ◯◯ | ◯◯ | ◯◯ |
| | Release force (N/25 mm) | 6.1 | 6.0 | 6.5 | 6.6 |
| Physical properties | Blended liquid low- | ◯ | ◯ | ◯ | ◯ |
| (before curing) | temperature stability | | | | |
| | | | | | Comparative |
| | | Example 5 | Example 6 | Example 7 | Example 1 |
| Melamine resin | (A-1) | | 100 | | |
| | (A-2) | 100 | | 100 | |
| | (A-3) | | | | |
| | (A-4) | | | | |
| | (A′-1) | | | | 100 |
| | (A′-2) | | | | |
| | (A′-3) | | | | |
| Acid catalyst (B) | Paratoluenesulfonic acid | 3 | 5 | 5 | 5 |
| Release | Polyorganosiloxane | | | 0.5 | |
| component (C) | | | | | |
| Solvent | Toluene | 927 | 1044 | 945 | 945 |
| Other component | Trimethylolpropane | | 11 | | |
| Physical properties | Coating film appearance | ◯◯ | ◯ | ◯◯ | X |
| (after curing) | Untreated PET adhesion | ◯ | ◯ | ◯ | X |
| | Solvent resistance | ◯ | ◯◯ | ◯ | ◯◯ |
| | Release force (N/25 mm) | 6.3 | 6.2 | 0.2 | 6.7 |
| Physical properties | Blended liquid low- | ◯ | ◯ | ◯ | X |
| (before curing) | temperature stability | | | | |

| | | Comparative | Comparative | Comparative |
|---|---|---|---|---|
| | | Example 2 | Example 3 | Example 4 |
| Melamine resin | (A-1) | | | |
| | (A-2) | | | |
| | (A-3) | | | |
| | (A-4) | | | |
| | (A′-1) | | | 100 |
| | (A′-2) | 100 | | |
| | (A′-3) | | 100 | |
| Acid catalyst (B) | Paratoluenesulfonic acid | 5 | 5 | 5 |
| Release | Polyorganosiloxane | | | 0.5 |
| component (C) | | | | |
| Solvent | Toluene | 945 | 945 | 945 |
| Other component | Trimethylolpropane | | | |
| Physical properties | Coating film appearance | ◯ | ◯◯ | X |
| (after curing) | Untreated PET adhesion | X | X | ◯ |
| | Solvent resistance | X | X | ◯◯ |
| | Release force (N/25 mm) | 6.8 | 7.1 | 0.2 |
| Physical properties | Blended liquid low- | ◯ | ◯ | X |
| (before curing) | temperature stability | | | |

### INDUSTRIAL APPLICABILITY

Regarding the thermosetting release coating agent composition containing an alkyl etherified melamine resin that is obtained in the present invention, not only does a layer (cured product layer) that is formed by applying and curing the composition have excellent releasability, but an appearance defect of a coating film (cured coating film) is also suppressed and characteristics such as adhesion and solvent resistance are excellent even in a case where the composition is cured at a low temperature. Therefore, for example, a release film including a release layer that is a cured product layer obtained from the thermosetting release coating agent composition according to one aspect of the present invention is useful for the fabrication of a ceramic green sheet that serves as a raw material of, for example, multilayer ceramic capacitors or the fabrication of a transfer foil sheet that is to be processed on the surface of a transfer target material. In addition, the thermosetting release coating agent composition also has excellent preservation stability and is thus also useful in that sense.

1. A thermosetting release coating agent composition comprising: an alkyl etherified melamine resin (A); and an acid catalyst (B),
wherein an alkyl ether group in the alkyl etherified melamine resin (A) comprises an ethyl ether group, and the alkyl etherified melamine resin (A) has a weight-average molecular weight of 500 to 1,100.

2. The thermosetting release coating agent composition according to claim 1, wherein the alkyl ether group in the alkyl etherified melamine resin (A) further comprises a methyl ether group, and a mole ratio of the methyl ether group to the ethyl ether group, (methyl ether group)/(ethyl ether group), is 90/10 or less.

3. The thermosetting release coating agent composition according to claim 1, wherein an average mole ratio of the alkyl ether group in the alkyl etherified melamine resin (A) to 1 mol of a triazine ring is 3 to 6.

4. The thermosetting release coating agent composition according to claim 1, wherein the acid catalyst (B) is p-toluenesulfonic acid.

5. The thermosetting release coating agent composition according to claim 1, further comprising a release component (C).

6. The thermosetting release coating agent composition according to claim 1, wherein a concentration of carbon (C14) derived from biomass in the total organic carbon in the alkyl etherified melamine resin (A) is 20 to 100%.

7. The thermosetting release coating agent composition according to claim 1, wherein a content of the alkyl etherified melamine resin (A) is 10 to 99 parts by weight with respect to 100 parts by weight of a solid content in the thermosetting release coating agent composition.

8. A laminate, comprising a cured product layer on at least one surface of a base material,
wherein the cured product layer is formed of the thermosetting release coating agent composition according to claim 1.

9. The laminate according to claim 8, wherein the base material is polyethylene terephthalate.

10. The laminate according to claim 9, wherein the base material is untreated polyethylene terephthalate.
